(19) United States
(12) Patent Application Publication
(10) Pub. No.: US 2025/0209688 A1
(43) Pub. Date: Jun. 26, 2025

(54) Generating Accessible (Colorblind Safe and WCAG-Compliant) Color Pairings, Palettes, and Design Systems Using Neural Networks, Machine Learning, and Algorithms

(71) Applicant: Christophe Drayton, Brooklyn, NY (US)

(72) Inventor: Christophe Drayton, Brooklyn, NY (US)

(21) Appl. No.: 19/074,452

(22) Filed: Mar. 10, 2025

(51) Int. Cl. G06T 11/00

(52) U.S. Cl. CPC G06T 11/001

(57) ABSTRACT

This invention discloses systems and methods for non-iteratively generating accessible, Web Content Accessibility Guidelines (WCAG) compliant color pairings, palettes, and design systems. The approach leverages pre-trained neural networks and machine-learning modules to compute fixed color-blind safeness scores and predict contrast ratios in a single pass without iterative feedback. A color engine automates the generation of accessible outputs, analyzes and corrects existing palettes, and produces balanced color ramps and gradients that maintain accessibility standards. An interactive interface integrates user-defined constraints, including brand identity colors, and outputs multiple color notation formats. Overall, the invention addresses accessibility challenges by ensuring both color harmony and usability for individuals with color vision deficiencies across diverse design contexts.

### REFERENCES CITED

### U.S. Patent Documents

U.S. Pat. No. 11,861,763 B2 Echevarria Vallespi
   Contrast ratio color picker
U.S. Pat. No. 11,651,530 B2 Echevarria Vallespi et al.
   Modification of color contrast ratio based on target contrast
U.S. Pat. No. 10,643,353 B2 Echevarria Vallespi et al.
   Contrast-ratio-based color generation
2021/0142531 A1 Echevarria Vallespi et al.
   Authoring and Optimization of Accessible Color Themes
2021/0142532 A1 Echevarria Vallespi et al.
   Authoring and Optimization of Accessible Color Themes
2023/0098695 A1 Echevarria Vallespi et al.
   Systems For Generating Accessible Color Themes
U.S. Pat. No. 11,335,299 B2 Estelle et al. Tonal Palette Generation

### OTHER PUBLICATIONS

### Academic Research

OP.1 Brettel, Hans, Françoise Viénot, and J. D. Mollon. “Computerized Simulation of Color Appearance for Dichromats.” Journal of the Optical Society of America A 14, no. 10 (1997): 2647-55. https://doi.org/10.1364/JOSAA.14.002647.
OP.2 Lillo, Julio, Leticia Álvaro, and Humberto Moreira. “An Experimental Method for the Assessment of Color Simulation Tools.” Journal of Vision 14, no. 8 (July 2014): Article 15. https://doi.org/10.1167/14.8.15.
OP.3 Sunaga, S., Ogura, T. & Seno, T. “Evaluation of a dichromatic color-appearance simulation by a visual search task.” OPT REV 20, 83-93 (2013). https://doi.org/10.1007/s10043-013-0013-6
OP.4 Machado, Gustavo M., Manuel M. Oliveira, and Luiz A. F. Fernandes. “A Physiologically-based Model for Simulation of Color Vision Deficiency.” IEEE Transactions on Visualization and Computer Graphics 15, no. 6 (2009): 1291-98. https://doi.org/10.1109/TVCG.2009.113.

### PRIOR ART

### Softwares

PA.1 TPGi Colour Contrast Analyzer (CCA)—https://www.tpgi.com/color-contrast-checker/
PA.2 Coblis—https://www.color-blindness.com/coblis-color-blindness-simulator/
PA.3 Vischeck—https://www.vischeck.com/

### Web Apps

PA.4 WebAim Contrast Checker—https://webaim.org/resources/contrastchecker/
PA.5 Adobe Color Contrast Analyzer—https://color.adobe.com/create/color-contrast-analyzer
PA.6 Adobe Color Blind Safe Analyzer—https://color.adobe.com/create/color-accessibility
PA.7 Tanuguru Contrast Finder—https://contrast-finder.tanaguru.com/result.html?foreground=%2359A825&background=%23DFF0D8&algo=Rgb&ratio=3&isBackgroundTested-false&distanceSort=asc
PA.8 Accessible Color Palette Builder—https://toolness.github.io/accessible-color-matrix/
PA.9 Hue Tone—https://huetone.ardov.me/
PA.10 Leonardo—https://leonardocolor.io/

### Figma Plugins

PA.11 Use Contrast—https://www.figma.com/community/plugin/1149686177449921115/use-contrast
PA.12 Stark—https://www.figma.com/community/plugin/732603254453395948/stark-contrast-accessibility-checker
PA.13 Color Blind—https://www.figma.com/community/plugin/733343906244951586/color-blind

### PURPOSE

The disclosed system and methods represent a novel and efficient approach to creating accessible and inclusive color pairings, palettes, and design systems. Designers are responsible for creating inclusive, accessible, Web Content Accessibility Guidelines (WCAG) compliant palettes, which require that color pairings (foreground against background) have a minimum ratio of 3:1 for large text and graphics, and 4.5:1 for regular text. Existing websites and software offer narrow, incomplete, time-consuming and cumbersome solutions that rely on users' knowledge of color accessibility to find the correct pairing.

By taking an approach based on the colorblind safeness and relative luminance of each color (compared to only foreground/background ratio), the invention provides safe distinguishable pairings that comply with WCAG contrast ratio criterion, regardless of hue, saturation, or luminosity levels. It alleviates the burden of compliance for designers, leaving them free to focus on aesthetics and creativity.

By integrating machine learning and accessibility standards, the invention provides a scalable solution for designers and developers worldwide, as it reduces the overhead computation of current algorithms, which generate an excessive amount of colors before finding a match. Optimized machine learning models support this scalability by providing a straightforward path without the computation overhead.

### BACKGROUND

Creating accessible and colorblind-safe color palettes is essential for inclusivity in digital and physical designs. Existing tools often rely on manual adjustments or limited algorithms that fail to account for the complexity of wide-range gamuts, contrast ratios, color blindness, and accessibility standards. The present invention leverages machine learning and neural networks to automate and optimize the creation of compliant color pairs, gradients, and schemes, effectively bridging this gap.

### PRIOR ART DISCUSSION

Across the spectrum, solutions exist to test for contrast ratio and color blindness and to generate harmonious colors, similar colors based on distance (Euclidean or Delta E), single WCAG-compliant (3:1 and 4.5:1, as per WCAG 1.4.3 Minimum Contrast Ratio criterion) color pair, or multiple color ramps known as design systems. However, they all fall short of efficiency, performance, or user-friendliness.

### Contrast Ratio

The contrast ratio is a numerical value representing the relative luminance difference between two colors, typically foreground and background, on a display. This ratio is calculated as the relative luminance of the brighter color (L1)+0.05 divided by the relative luminance of the darker color (L2)+0.05, expressed as L1: L2. The 0.05 offset accounts for ambient light effects and flare, which is the light scattered within the eye or on the display surface, affecting perceived contrast. This adjustment helps the calculated contrast ratio more accurately reflect real-world viewing conditions. The contrast ratio is a critical parameter in determining the readability and accessibility of visual content, as it directly impacts users' ability, including those with visual impairments, to distinguish and interact with information. Compliance with accessibility standards, such as the Web Content Accessibility Guidelines (WCAG), often necessitates achieving specified minimum contrast ratios to ensure content is perceivable by a broad range of users.

Available contrast checkers such as CCA (PA.1), Webaim (PA.4), or Figma Plugins such as Use Contrast (PA.12) or Stark (PA.13), specifically narrow the path to efficient accessibility by presenting only 1% of possible matches to a selected color (based on the saturation level of the input color in the HSL color space), expanding the user's time of a searchable match by 99% (as HSL has 100 saturation values). Per our preliminary research, half of the users stated that they were unhappy with the contrast of their palette.

Adobe Color Contrast Analyzer (PA.5) presents two to three possible WCAG-compliant combinations (U.S. Pat. No. 11,651,530/B2). However, in the graphical user interface of the web app, the offered combinations are only located in the same hue as the input color, hidden per default, and available only if the user selects them. The system uses the equation Y_{f}=R×(Y_{bg}+0.05)−0.05, derived from the WCAG contrast ratio formula, to estimate the targeted ideal luminance for a color pair. This narrows the path to accessible colors further as it relies on two colors to make that assumption, strengthening the idea for the users that very few colors match the targeted contrast ratio. Furthermore, it assumes that the base color for calculation is the background and updates the foreground color. This is not explicitly notified to the user, obscuring their understanding of a workable, accessible solution.

Tanaguru Contrast Finder (PA.7) is the only solution on the market to provide multiple similar colors by using the Euclidian distance in the RGB space. However, these methods require a heavy computational load. Available market algorithms have to generate hundreds—if not thousands—of colors before filtering those that match the targeted contrast ratio. In this specific example, Tanaguru filtered 1,434,720 colors only to find 50 matching colors, generating a loss of 99.997%.

Another Adobe solution, Contrast Ratio Picker (U.S. Pat. No. 11,861,763/B2), recalculates RGB values multiple times until it reaches the targeted contrast ratio, which is computationally more sound. However, it limits the number of colors processed to generate the filtered palette.

While these solutions provide various methods to identify WCAG-compliant color combinations, they fail to offer clear guidance on selecting the most appropriate colors for accessibility in specific contexts. Users are often left to interpret the output without understanding how certain color combinations might enhance readability, visibility, or overall user experience. Furthermore, these tools focus predominantly on achieving compliance with contrast ratio thresholds rather than emphasizing the usability or aesthetic compatibility of the suggested colors. This lack of actionable insights or recommendations for optimal color choices can leave users uncertain about which combinations best address the needs of diverse audiences, particularly individuals with visual or cognitive impairments.

### Color Ramps & Design Systems

A color ramp is a sequential arrangement of colors that transition smoothly between two or more defined endpoints, often representing variations in luminance, hue, or saturation. Color ramps are commonly used in design, data visualization, and digital graphics to create gradients, define color schemes, or visually represent data in a continuous spectrum. Each step within a color ramp maintains a consistent progression based on defined rules, such as equal luminance or perceptual contrast changes, ensuring a visually coherent transition. In accessibility-focused design, color ramps are critical in maintaining sufficient contrast ratios across the spectrum, making visual content perceivable to users with various visual impairments or in challenging lighting conditions.

Color ramps form the foundational building blocks of a design system by establishing a structured and consistent palette that guides the visual identity of a product or interface. These ramps provide a scalable framework for applying colors across various design elements, such as backgrounds, text, buttons, and data visualizations, ensuring harmony and coherence. By incorporating accessibility considerations like contrast ratios and perceptual balance, color ramps enable designers to create inclusive and aesthetically pleasing designs that meet functional and branding requirements.

Solutions exist to create and test accessible color ramps and entire design systems. However, there is no community consensus on what constitutes an accessible and scalable color ramp (reproducible across different hues). As a result, solutions such as Accessible Color Palette Builder (PA.8) or Hue Tone (PA.9) present accessible pairs across inputs from the user, with results that are neither automated (the user needs to change each color across the color ramp) nor scalable (results vary from one hue to another).

Leonardo (PA.10), Adobe's open-source project, offers a comprehensive approach to color accessibility. However, the engineer-like display with graphs across multiple color spaces is not user-friendly.

Google's tonal palette generation (U.S. Pat. No. 11,335,299/B2) involves a process where an input color is matched with a curated reference palette based on calculated color distances using metrics like CIE Delta E2000. The system identifies the closest palette by evaluating the mathematical relationships between the input color and colors in reference palettes. It then selects a matching color from the chosen palette and uses vector interpolation in a multidimensional LAB color space to compute offset values. These offsets generate a new tonal palette—or color ramp—ensuring visual harmony and accessibility standards while maintaining the input color's characteristics.

None provide guidance on an optimal recommended ramp other than the industry standard (e.g., WCAG 2.1 Color Contrast 1.4.3 criterion).

From a computational perspective, the current systems generate an immense number of colors—often exceeding 100 options—to find just one that meets a targeted contrast ratio. A 5-color palette with 10 colors per ramp would require generating at least 5,000 colors (5 hues×10 ramp colors×100 generated colors per match), resulting in a staggering computational overhead. This inefficiency increases processing time, leading to slow rendering and suboptimal user experiences, but also highlights a more profound limitation: none of these solutions provide clear guidance on crafting an optimal, accessible color ramp. Instead, they rely solely on adherence to industry standards like the WCAG 2.1 Color Contrast 1.4.3 criterion, offering no practical recommendations or scalable methodologies to ensure usability, visual harmony, or consistency across hues. This gap leaves users to rely on trial-and-error approaches, perpetuating inefficiencies and inconsistent results in accessible design.

### Color Blindness Simulation and Optimization

Color blindness simulation and optimization are critical components in generating inclusive color palettes, ensuring designs are accessible to individuals with color vision deficiencies (CVD). Approximately 8% of men and 0.5% of women worldwide experience some form of CVD, which affects their ability to distinguish specific colors. By simulating how a palette appears to users with various types of color blindness, such as protanopia, deuteranopia, or tritanopia, designers can identify potential accessibility issues early in the design process. Optimization takes this further by adjusting colors to enhance distinguishability and maintain contrast, creating visually appealing and functional palettes for all users. These practices are essential for adhering to accessibility standards and fostering an inclusive user experience.

Another major drawback of existing solutions is colorblind safeness. Web apps such as Coblis (PA.2), Vischeck (PA.3), and Figma plugins such as Color Blind (PA.13) or Stark (PA.12) simulate Color Vision Deficiencies (CVD, e.g., protanopia, deuteranopia, and tritanopia). However, for the sake of performance and computation, they rely on outdated research (OP.1). Since its publication, the simulation has been tested, debated, and proven inaccurate (OP.2, OP.3, OP.4). Therefore, the use of this algorithm is damaging not only to the design community as a whole, as some are considered industry leaders, but also to the millions of users impacted by CVD.

At the time of filing, Adobe Color Blind Safe Analyzer is the only known product that provides a solution when its system considers color incompatible with colorblindness (Patents US 2021/01442532 A1, 2021/0142532 A1, and 2023/0098695 A1). Its system calculates the distance between the color input by a user and the confusion line in the corresponding CVD to determine if a conflict exists. It then proceeds with weighted algorithms and transformations through different color spaces to output a color away from the confusion line and aesthetically pleasing, making it colorblind-safe and, thus, accessible. However, the methods described have several limitations, namely color spaces, CVD prevalence, and user-triggered automation.

Even if the patents allow for future color spaces, the algorithms and transformations are rooted in the CIE XYZ and CIE Lab color spaces. The XYZ color space is a mathematical representation of colors based on human vision created in 1931 by the International Commission on Illumination (CIE). The LAB color space was designed to be perceptually uniform and transform values from the XYZ color space to approximate human vision. However, both are context-dependent on a Reference White Point (e.g., D65 or D50), don't accurately model extreme (very dark or very light) or highly saturated colors, and are known to compress the blue range, creating artifacts or out-of-spectrum values, making them improper for testing. Adobe's methods and systems use Delta E to quantify color differences. However, older formulas (e.g., Delta E76) are not perceptually accurate. Even improved versions (e.g., Delta E2000) highlight LAB's underlying limitations. Lastly, the LAB color space is not suited for modern technologies, such as HDR or wide-gamut displays, resulting in a misalignment of the proposed output color with today's screens.

The methods and systems described in the patents use multiple weights to balance accessibility, aesthetics, and closeness to the input color. However, regardless of its prevalence, they treat each CVD with the same importance, which overrepresents issues in their analysis. For example, given the global population, it is estimated that approximately 0.001% of men and 0.03% of women live with tritanopia, compared to 5% of men and 0.35% of women living with deuteranomaly. Treating all CVD equally might flag a color pairing as inaccessible and portray the palette as problematic for all when it is only inaccessible for a small subset of users, making it an edge case.

Lastly, the methods and systems described rely on user-triggered processes rather than automated solutions, significantly increasing the time and effort required to create accessible, harmonious, and colorblind-safe palettes. Users must manually initiate simulations, adjust colors, and verify results for each combination, which is inefficient and ineffective, especially for large-scale projects or iterative design workflows. The lack of streamlined automation means users must invest considerable time navigating complex interfaces and repeatedly testing colors, detracting from their ability to focus on creativity and innovation. This time-consuming approach, combined with the prevalence of outdated algorithms and limitations in addressing modern display technologies, underscores the ineffectiveness of these solutions in delivering optimal, accessible, and scalable color palettes for today's design needs.

### SUMMARY

The disclosed system integrates two machine learning models, two novel metrics, and a color engine to achieve accessibility and compliance: a novel metric called CVDx (Color Vision Distinguishing Index) assigns a safeness score to each color; a novel metric called CVDxR or xR (Color Vision Distinguishing Index Ratio) calculates a safeness ratio between two colors; a first machine learning model, based on neural networks trained on CVDx data, predicts and identifies safe pairing colors for individuals with color vision deficiencies (e.g., protanopia, deuteranopia, and tritanopia); a second machine learning model, based on neural networks trained on relative luminance data, predicts corresponding contrasted colors for any color and contrast level; a color engine generates pairings, ramps, palettes, and a design system that maintains harmony and accessibility.

The system processes user-defined inputs, applies accessibility standards defined by WCAG, and produces outputs including: automated accessible (colorblind-safe and WCAG-compliant) pairs (within the same hue, in another hue, or across the color wheel); automated balanced color ramps with minimum contrast ratios of 3:1, 4.5:1, and 7:1; automated accessible gradients with a constant minimum contrast ratio of 3:1 against the foreground color; automated colorblind-safe pairings, palettes, and design systems.

### BRIEF DESCRIPTION OF THE DRAWINGS

The present invention is described in detail below with reference to the attached drawing figures, wherein:

FIG. 1 is a schematic depiction of an accessible design system using the two machine learning models in accordance with the embodiments of the present disclosure.

FIG. 2 is a depiction of an automated color engine using the two machine learning models for generating accessible pairings, palettes, and design systems in accordance with the embodiments of the present disclosure.

FIG. 3 is a depiction of an automated color engine using the two machine learning models for analyzing and fixing accessible pairings, palettes, and design systems in accordance with the embodiments of the present disclosure.

FIG. 4 is a schematic diagram showing an example of a balanced color ramp generated by the system in accordance with the embodiments of the present disclosure.

FIG. 5 is a schematic diagram showing an example of an accessible gradient annotated with contrast ratios generated by the system in accordance with the embodiments of the present disclosure.

FIG. 6 is a schematic diagram showing an example of an accessible design system in accordance with the embodiments of the present disclosure.

### DETAILED DESCRIPTION

### Overview

Color contrast plays a critical role in ensuring the usability and accessibility of visual designs. It affects how users perceive and interact with digital interfaces, print materials, and physical products. Proper contrast is essential for users with typical vision and those with low vision, cognitive impairments, or other conditions that affect visual processing. High-contrast elements, such as text and backgrounds, are easier to distinguish and read, improving comprehension, navigation, and overall user experience. The system addresses this need by using machine learning to predict and maintain contrast ratios that comply with WCAG (Web Content Accessibility Guidelines) standards, including levels of 3:1, 4.5:1, and 7:1. These standards ensure designs meet the needs of diverse audiences, from users with mild visual impairments to those requiring maximum accessibility.

For individuals with Color Vision Deficiencies (CVD), accessing information in color-dependent designs can be a significant challenge. CVD, which affects approximately 8% of men and 0.5% of women globally, limits the ability to distinguish between specific colors, such as reds and greens or blues and yellows. Inaccessible color palettes can exclude these individuals from fully engaging with products, services, or content, leading to frustration and inequality. The invention's novel metrics, CVDx and CVDxR, quantify color safeness and distinguishability, enabling the system to generate palettes that work effectively for people with different types of CVD, such as protanopia, deuteranopia, and tritanopia. This proactive approach ensures that color is used as a tool for inclusion rather than a barrier.

The importance of accessible color design extends beyond the user experience to include legal and ethical considerations. Governments and regulatory bodies worldwide enforce accessibility standards like WCAG to ensure that digital products and services are usable by everyone. Non-compliance can result in legal actions, fines, and reputational damage for companies. More importantly, the lack of accessibility excludes millions of potential users, diminishing a brand's reach and inclusivity. By automating the creation of accessible, colorblind-safe palettes, this invention empowers designers and companies to meet these legal requirements effortlessly while fostering a more inclusive design culture.

The disclosed invention provides an end-to-end system for generating accessible color palettes, ensuring inclusivity for users with varying visual abilities. By leveraging machine learning, the system delivers outputs optimized for contrast, colorblind safety, and harmony.

### Workflow

Input: Users provide a base color or an existing color palette.
Processing: The first machine learning model analyzes, identifies safe colors, or optimizes colors for colorblind users. The second machine learning model predicts colors matching contrast ratios. The color engine generates pairings and clusters them into color ramps, gradients, and accessible color systems.
Output: The system produces: balanced color ramps (3:1, 4.5:1, 7:1), accessible gradients maintaining at least 3:1 contrast ratios, palettes optimized for colorblind safety and harmony, accessible pairings across all generated colors, and a design system comprising a colorblind safe palette, color ramps, and accessible pairs.

### Components

### Color Vision Distinguishability Index (CVDx)

The Color Vision Distinguishability Index, or CVDx, is a novel single-value metric designed to evaluate how safe or distinguishable a given color is for individuals with color vision deficiencies. It integrates multiple factors, such as luminance, chromatic shift, and distances from known color-blind confusion lines, into a unified score. By weighting each factor according to the prevalence and severity of common color-blind conditions, CVDx provides a streamlined, quantitative measure that indicates whether a specific color is likely to remain distinguishable across the most common types of color vision impairment.

### Input/Output

The CVDx system accepts a single color provided by the user, or the system defaults and assigns a score between 0 and 1.

### Overview of Sub-Metrics

Below is an illustrative mathematical formulation for the Color Vision Deficiency Index (CVDx). It shows how multiple sub-metrics are computed, weighted, and combined into a single measure ranging from 0 to 1 ([0 . . . 1]), where higher values indicate that a color is generally “safer” for color vision deficiencies.

CVDx uses four key sub-metrics, each normalized to [0 . . . 1]: Luminance Metric, L_{w}, a normalized (e.g., weighted by prevalence) measure of how bright the color remains under color-blind simulations. Larger L_{w}

means higher adequate brightness. Chroma Metric, C_{w}, a normalized measure of how much chroma (saturation) remains distinguishable under color-blind simulations. Larger C_{w}
means greater retained chroma. Shift Metric, shiftVal, a normalized measure of how drastically a color shifts in OKLab (or any similar space) when simulated for different color-blind conditions. Larger shiftVal indicates a more considerable shift, which is considered worse. This factor is implemented into a “bigger is better” final formula, using 1−shiftVal.
Confusion Index, cciVal, a normalized measure of how far the color lies from known color-blind confusion lines (weighted by deficiency prevalence). Larger cciVal indicates safer distances from confusion lines.

Each sub-metric is derived from color transformations (e.g., but not limited to, SRGB→linear RGB→OKLab) and color-blind simulations (e.g., Protanopia, Deuteranopia, Tritanopia) using standard or proprietary methods.

### Weighted Combination

CDVx uses the following importance weights:
w_{L}: weight for the Luminance Metric;
w_{C}: weight for the Chroma Metric;
w_{S}: weight for the Shift Metric; w_{CCI}: weight for the Confusion Index.

A weighted average gives the final CVDx score:

$$CVDx = \frac{{w}_{L} {L}_{w} + {w}_{C} {C}_{w} + {w}_{S} ( 1 - shiftVal ) + {w}_{CCI} cciVal}{{w}_{L} + {w}_{C} + {w}_{S} + {w}_{CCI}}$$

When shiftVal is large (indicating a significant undesirable color shift), 1−shiftVal becomes smaller, which reduces the overall CVDx. High L_{w}, L_{w}, or cciVal each increases the final CVDx.

### Example St Metric Computations

L_{w}—Luminance, extracts the relative luminance under color-blind simulations, forming a weighted average normalized to [0 . . . 1]. Formally:

$${L}_{w} = min ( 1 , \frac{{\sum }_{i} ( {w}_{i} {Y}_{i} )}{maxLuminance} ) ,$$

where Yᵢ is the luminance under deficiency i, wᵢ are deficiency prevalence weights, and max Luminance is a reference.
C_{w}—Chroma, compares the color's chroma between normal vision and color-blind simulations (e.g., OKLCH C), forming a weighted average normalized to [0 . . . 1]. Formally:

$${C}_{w} = min ( 1 , \frac{{\sum }_{i} {w}_{i} \vert {C}_{normal} - {C}_{sim , i} \vert}{maxChromaDiff} ) ,$$

A larger C_{w} implies the color retains more saturation or difference from its normal vision version.
shiftVal—Shift, derived by measuring the shift in OKLab between normal vision and color-blind simulations, forming a weighted average normalized to [0 . . . 1]. Formally:

$$shiftVal = min ( 1 , \frac{‖ {OKLab}_{normal} - {OKLab}_{simulated} ‖}{maxShift} ) ,$$

so that 0 means no shift and 1 means very large shift.
cciVal—Color Confusion Index, sums the perpendicular distances from the color to each deficiency's confusion line, weighted by, forming a weighted average normalized to [0 . . . 1]. Formally:

$$cciVal = min ( 1 , \frac{{\sum }_{i} ( {w}_{i} {d}_{i} )}{maxCciValue} ) ,$$

where dᵢ is the distance in OKLab to the confusion line for deficiency i. More significant values mean the color is far from all confusion lines.

### Final Interpretation

A color with CVDx≈1 is bright, stable, and far from color-blind confusion lines across the major types of color vision deficiency. A color with CVDx≈0 is prone to significant contrast loss or confusion. The exact thresholds (e.g., CVDx≥0.7) vary by design needs and can be tuned based on empirical testing or user feedback.

### Color Vision Distinguishability Index Ratio (CVDxR or xR)

The CVDx ratio (CVDxR or xR) is a pairwise comparative measure derived from each color's individual CVDx score to determine whether two colors remain adequately distinguishable for individuals with color vision deficiencies. By computing the ratio of their respective CVDx values, one can easily indicate whether the two colors will likely cause confusion. In particular, threshold values for the CVDx ratio can be established to label color pairs as safe or not, providing a practical guideline for color selection in user interfaces, product design, or any application sensitive to color contrast requirements under various types of color blindness.

### Input/Output

The system accepts two CVDx values retrieved from the first machine learning model and assigns a ratio.

### Overview

Below is an illustrative mathematical formulation for the CVDx ratio, a pairwise metric that compares the Color Vision Deficiency Index (CVDx) scores of two different colors to determine whether those colors remain sufficiently distinguishable under color-vision deficiencies.

### Example Ratio Computation

Let each color α and β have an associated CVDx value:

CVDx(α), CVDx(β)∈[0, 1] These are single-color safety scores (e.g., from the previous CVDx formula), where higher values indicate a color is generally less prone to color-blind confusion. To compare two colors, we define the CVDx Ratio x_{R} as:

$${x}_{R} = \frac{max ( CVDx ( α ) , CVDx ( β ) ) + ε}{min ( CVDx ( α ) , CVDx ( β ) ) + ε} ,$$

where ε is a small positive constant (e.g., 0.001) chosen to prevent division by zero and to ensure numerical stability. If x_{R}≈1, both colors have nearly the same CVDx score, making their pairwise safety uncertain—mainly if both scores are low. If x_{R} is substantially greater than 1: One color is significantly safer than the other, thereby reducing the likelihood that both collapse into confusion for the same type of color blindness.

### Final Interpretation

A threshold T may be introduced to classify pairs as safe or unsafe. If x_{R}≥T, the pair is deemed sufficiently distinguishable. For instance, a threshold of T=1.3 means that if the higher CVDx score is at least 30% larger than the lower score, the two colors are likely distinct enough for most color-blind viewers. Conversely, if T<1.3, additional scrutiny may be warranted to avoid confusion under various color vision deficiencies. Thus, the CVDx Ratio provides a concise numerical measure for deciding when two colors, individually safe or risky, are still distinguishable pairwise for color-blind individuals.

### First Machine Learning Model

The described model applies principles of supervised learning to predict the Color Vision Distinguishability Index (CVDx) with high accuracy. It uses a hierarchical structure inspired by Multi-Layer Perceptrons (MLPs).

### Input/Output

The model accepts a base color or existing color palette created by the user and provides a predicted list of safe colors for individuals with Color Vision Deficiencies (e.g., protanopia, deuteranopia, and tritanopia).

### Overview

Initial data consists of 43,200,000 vectors generated from four parameters (Lw, Cw, Sw, and CCIw) calculated over all available digital colors (e.g., across different color spaces and gamut) and Color Vision Deficiencies (e.g., protanopia, deuteranopia, tritanopia) compressed into 3,600,000 CVDx labeled vectors.

This data trains the model by minimizing the error between predicted and actual CVDx values. Through supervised learning, the model progresses through four layers: the initial data is compressed 100 times into weighted polynomials, segmented into smaller polynomials, and further optimized into master polynomials with an additional weighting parameter. Each layer functions as a step in the learning process, refining the representations and weights to capture the intricate relationships in the data.

This architecture mirrors the structure of fully connected neural networks, where each layer learns increasingly abstract features. The result is a compact model with 578,160 parameters that achieve industry-standard accuracy.

This layered, supervised approach ensures efficient computation and reliable predictions while maintaining the interpretability of the model.

### Second Machine Learning Model

The second model described leverages supervised learning principles to accurately predict the matching colors to a set of targeted contrast ratios for a given color. It employs a hierarchical structure inspired by Fully Connected Neural Networks (FCNNs) or Multi-Layer Perceptrons (MLPs).

### Input/Output

The model accepts a base color input by the user and provides a predicted list of matching colors for the base color based on targeted contrast ratios across a spectrum of potential pairings.

### Overview

The initial data comprises 3,600,000 vectors representing relative luminance values derived from WCAG relative luminance computations.

This data is processed through three layers: first, it is modeled into weighted polynomials, each segmented into smaller polynomials for finer granularity. These are subsequently compressed into master polynomials, each incorporating an additional weighting parameter for optimal representation.

The model uses 577,800 parameters, with each layer functioning as a refinement step to capture the complex relationships inherent in contrast calculation. By minimizing prediction error, this architecture mirrors the abstraction process of an FCNN, where each layer learns progressively more nuanced features.

This layered, supervised approach results in an efficient, compact model that achieves industry-standard accuracy in predicting contrast ratios. This enables reliable predictions across diverse input scenarios.

### Environment

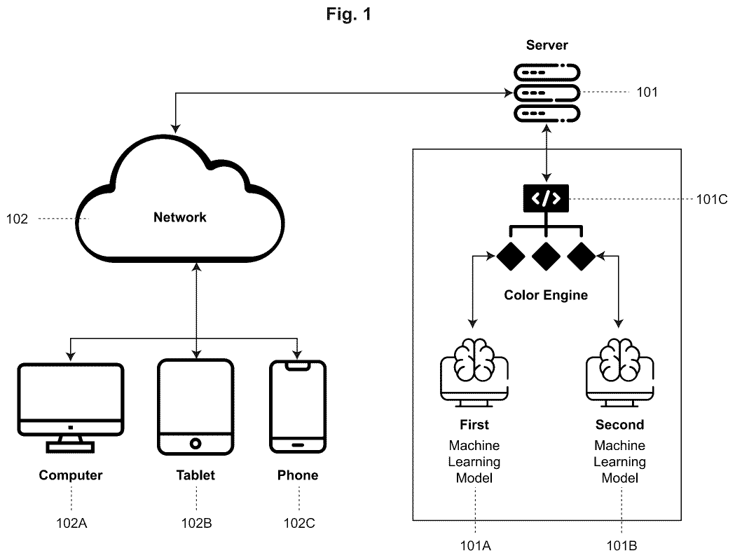

FIG. 1 is a schematic depiction illustrating an exemplary accessible color generation environment in which some embodiments of the present disclosure may be employed. Among other components not shown, an accessible color generation environment may include a color engine (101C), two machine learning models (101A and 101B), user devices such as user devices (102A, 102B, and 102C), and a distributed computing environment (101). The distributed computing environment (101) hosts the accessible color generation engine (101C) and two machine learning models (101A and 101B).

It should be understood that the accessible color generation environment shown in FIG. 1 is one example of a suitable computing system. Any of the components depicted in FIG. 1 may be implemented via any type of computing device. These components may communicate with each other via one or more networks (102), which may include, without limitation, one or more local area networks (LANs) and/or wide area networks (WANs). Such networking environments are commonly found in offices, enterprise-wide computer networks, intranets, and the Internet.

This arrangement, as well as other configurations described herein, is provided only as an example. Other arrangements and elements (e.g., devices, interfaces, functions, orders, groupings of functions, etc.) may be employed in addition to or instead of those shown, and some elements may be omitted entirely. Additionally, many components described herein are functional entities that may be implemented as standalone or distributed components or integrated with other components in any suitable combination and location. Various functions described herein as being performed by one or more entities may be executed via hardware, firmware, and/or software. For instance, a processor may perform these functions by executing instructions stored in memory.

This configuration allows the accessible color engine (101C) to leverage machine learning models and algorithms hosted in distributed environments to efficiently and effectively deliver accessible, colorblind-safe, and WCAG-compliant color pairings, palettes, and design systems.

### Color Engine

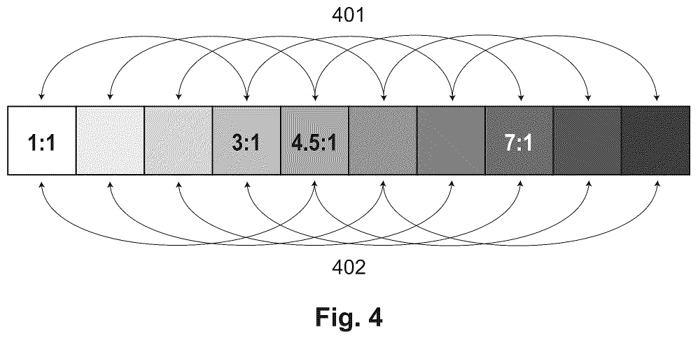

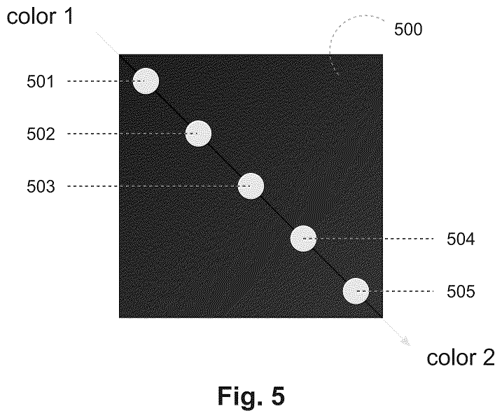

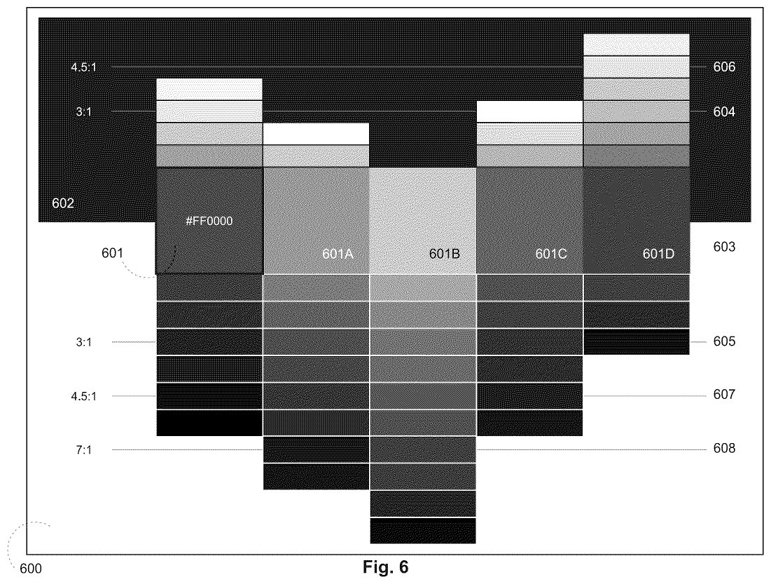

The Color Engine is the invention's core component. It is designed to automate the creation and analysis of accessible (colorblind-safe and WCAG-compliant) color pairings, ramps (FIG. 4), gradients (FIG. 5), palettes and design systems (FIGS. 6-600). By integrating the outputs of two advanced machine learning models along with novel metrics such as CVDx and CVDxR, the Color Engine ensures that all generated designs meet rigorous accessibility standards while maintaining visual harmony tailored to specific design contexts, such as branding, digital interfaces, and print media. These palettes are further expanded into accessible design systems that ensure usability across various platforms and interaction types.

### Input/Output

The engine accepts a base color provided by the user or system defaults, retrieves safe colors predicted by the first machine learning model, and matches color predictions from the second machine learning model. It then produces accessible pairings, ramps, palettes, and design systems that maintain visual harmony and comply with WCAG guidelines.

### Overview

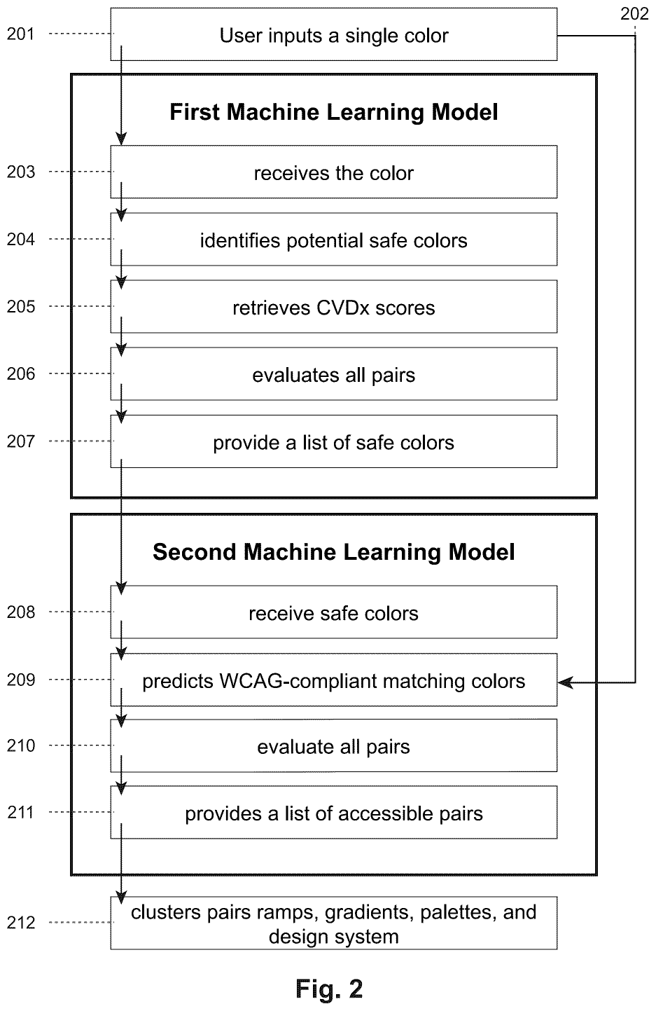

The Color Engine begins by processing user-defined inputs, such as a base color (FIG. 2—201, 202, FIG. 6—601), and incorporates predictions from the first machine learning model to identify safe and accessible color pairings (FIG. 2—204). The first machine learning model retrieves Color Vision Distinguishability Index scores (CVDx) to colors (FIG. 2—205) and evaluates potential pairings (FIG. 2—206) to ensure distinguishability for individuals with various color vision deficiencies (FIG. 6—601A, 601B, 601C, 601D). The CVDxR metric ranks these pairings, ensuring that the most accessible and usable combinations are prioritized (FIG. 2—207). Concurrently, the second machine learning model predicts precise WCAG-compliant matching colors (FIG. 2—208, 209), enabling the system to verify (FIG. 2—210) that all generated outputs comply with WCAG-defined contrast thresholds (FIG. 2—211). Together, these allow the Color Engine to produce a wide range of accessible color pairings, including options within the same hue, or across the color wheel (FIG. 2—212).

In addition to pairing generation, the Color Engine automates the creation of balanced WCAG-compliant color ramps (FIG. 4), adhering to specific contrast levels of 3:1 (FIG. 4—401), 4.5:1 (FIG. 4—402), and 7:1. It also generates accessible gradients that maintain a constant minimum contrast ratio of 3:1 (FIG. 5—500) against specified foreground colors verified by an interpolation algorithm that tests for compliance across multiple points of the gradient (FIG. 5—501, 502, 503, 504, 505). These features make it possible to produce color schemes that are both functional and visually appealing.

The second machine learning model then enables the Color Engine to predict contrast ratios on a dark background (FIG. 6—602) and on a light background (FIG. 6—603) and to accurately predict contrast ratio matches between the base color (FIG. 6—601) and all colors of the system, whether on a dark background for a minimum ratio of 3:1 (FIG. 6—604) and 4.5:1 (FIG. 6—606) or on a white background for a minimum ratio of 3:1 (FIG. 6—605) and 4.5:1 (FIG. 6—607). Ratios above 4.5:1 depend on the relative luminance of a color and their relationship with the background. When possible, the ratios of 7:1 between the base color (FIG. 6—601) and the generated colors are displayed (FIG. 6—608).

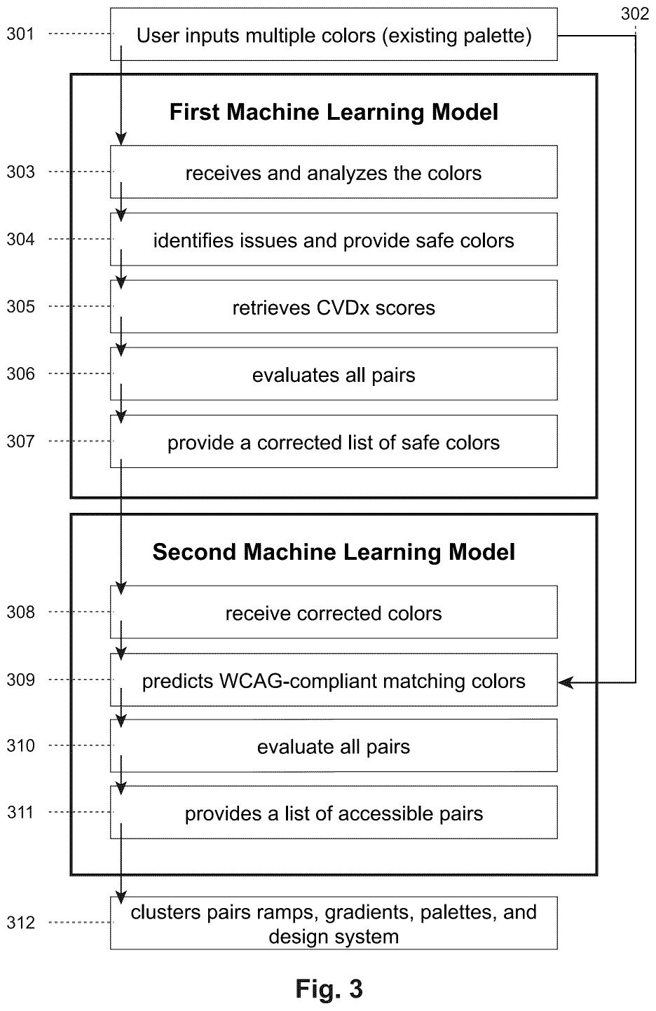

The system also includes capabilities for analyzing and fixing existing color palettes and design systems (FIG. 3). By identifying accessibility issues and automatically generating compliant alternatives, the Color Engine streamlines the process of creating inclusive designs. This functionality is particularly valuable for designers who retrofit accessibility into pre-existing projects. In this particular case, users input their existing colors (FIG. 3—301) in 601A, 601B, 601C, and 601D. The Color Engine will then analyze these colors through the first machine learning model (FIG. 3—303, 304, 305, 306) and provide corrections (FIG. 3—307). The second machine learning model will expand the system with balanced color ramps corresponding to the new corrected palette (FIG. 3—308, 309, 310, 311, 312).

The Color Engine is built with adaptability and scalability in mind. It dynamically adjusts outputs based on user preferences, such as desired base colors. Its integration with the pre-trained machine learning models enables it to retrieve color safeness scores, pairing predictions, and contrast data, which drive the systems that produce harmonious and accessible outputs. The system supports multiple formats, including digital color codes (e.g., HEX, RGB, OKLCH) and templates for design software, making it versatile and easy to implement in various workflows.

This innovative engine stands out for its accessibility-first approach, automating the creation of colorblind-safe and WCAG-compliant designs without sacrificing aesthetics. By addressing common challenges in inclusive design, the Color Engine empowers designers of all skill levels to create visually harmonious and accessible color systems efficiently and effectively.

These claims collectively cover the method, system, and computer-readable medium aspects of generating automated, accessible (color-blind-safe and WCAG-compliant) color pairings, palettes, and design systems using machine learning and novel metrics (CVDx and CVDx ratio).

Although implementations of contrast-ratio-based color generation have been described in language specific to features and/or methods, the appended claims are not necessarily limited to the specific features or methods described. Rather, the specific features and methods are disclosed as example implementations of contrast-ratio-based color generation, and other equivalent features and methods are intended to be within the scope of the appended claims. Further, various examples are described and it is to be appreciated that each described example can be implemented independently or in connection with one or more of the other described examples.

The following claims describe a method and system wherein fixed, one-time computations are employed to determine accessibility scores and contrast ratios. However, it is expressly contemplated that incorporating an iterative framework for refining or augmenting these computed values is not excluded by the disclosure of the non-iterative process. In other words, while the claims focus on a fixed, non-iterative computation for clarity and determinacy, additional iterative steps or processes may be integrated without departing from the scope of the invention.

What is claimed is:

1. A method for generating accessible color pairings, palettes, and design systems, comprising: receiving an initial color input, and predefined accessibility standards;
employing a pre-trained machine-learning module that, in a single, non-iterative pass and without any real-time iterative feedback, computes fixed color-blind safeness scores (CVDx) based solely on intrinsic color properties; combining the computed safeness scores using a proprietary, one-time non-iterative algorithm to generate a unique Color Vision Distinguishing Index Ratio (CVDxR) based on non-iterative machine learning-driven analysis; employing a second pre-trained machine-learning module that, in a single, non-iterative pass, predicts a color ramp of darker to brighter colors for each color of the palette, wherein each pair respects WCAG contrast requirements, without iterative relative luminance computation; selecting only those color pairings that satisfy predetermined, fixed CVDxR and accessibility compliance thresholds exclusively derived from said non-iterative machine learning-based computations; and outputting one or more accessible color outputs comprising the color pairings, palettes, and design system elements.

2. The method of claim 1, wherein the machine learning module is pre-trained on an extensive dataset of color vision deficiency simulations and computes the fixed safeness scores without real-time or iterative feedback.

3. The method of claim 1, wherein the second machine learning module is pre-trained on an extensive dataset of relative luminance and outputs one or multiple predicted corresponding contrasted colors, thereby precluding any iterative updates.

4. The method of claim 1, wherein the color engine generates balanced color ramps by employing a predetermined, non-iterative selection algorithm that uses pre-simulated color vision deficiency criteria and predetermined contrast milestones to directly arrange candidate colors without resorting to iterative refinement.

5. The method of claim 1, wherein the color engine automatically identifying and replacing, using simultaneously two dedicated pre-trained machine-learning modules, in a single, non-iterative pass, any colors in an existing palette that fail to achieve both a computed fixed CVDx score threshold and a minimum contrast ratio, thereby actively correcting the palette rather than merely masking non-compliant colors, thereby distinguishing the process from mere visual masking or filtering techniques.

6. The method of claim 1, further comprising generating a color gradient that maintains at least a 3:1 contrast ratio against a specified foreground or background color, continuously evaluated under simulated color vision deficiency conditions.

7. The method of claim 1, wherein selecting accessible color combinations comprises ranking each pairing by the product of its assigned CVDx ratio and its computed contrast ratio to prioritize combinations that optimize both color-blind safety and contrast compliance.

8. The method of claim 1, further comprising outputting data in multiple color notation formats, including but not limited to HEX, RGB, HSL, and OKLCH, for use in various design applications with integrated simulation previews.

9. A system for generating accessible color pairings, palettes, and design systems, comprising: one or more processors and a memory storing program instructions; a first pre-trained machine-learning module configured to simulate color vision deficiencies and compute fixed color-blind safeness scores (CVDx) in a single, non-iterative pass based solely on intrinsic color properties; a second pre-trained machine-learning module configured to predict contrasted colors via fixed contrast ratios determined in a single, non-iterative pass that avoids iterative relative luminance calculations; a color engine operatively coupled to the machine-learning modules that uniquely integrates the computed CVDx scores and predicted contrasted colors to generate accessible color outputs without iterative refinement; and an interactive user interface configured to display the accessible color outputs along with machine-learning-simulated previews of color vision deficiencies.

10. The system of claim 9, wherein the color engine further comprises an interactive interface configured to display generated accessible color outputs alongside machine learning-simulated previews under various color vision deficiency conditions.

11. The system of claim 9, wherein the second machine-learning module employs a neural network to predict contrast ratios by analyzing relative luminance differences, and wherein the module applies a predetermined, non-iterative decision boundary for user feedback-ensuring that any dynamic user input is processed in a single pass without iterative updating of thresholds.

12. The system of claim 9, further comprising a memory storing a dynamic ruleset that adjusts fixed minimum CVDx ratio thresholds based on pre-defined design context parameters and one-time user input, thereby ensuring that the thresholds remain constant during each non-iterative generation process, and are distinct from continuously adjustable contrast ratio thresholds.

13. The system of claim 9, wherein the interactive interface module is configured to receive user-defined constraints, including brand identity colors and design preferences, and dynamically integrate these inputs into the machine learning-driven generation of accessible color palettes with real-time simulation feedback.

14. The system of claim 9, wherein the color engine produces recommended accessible color palettes, each comprising at least three brightness levels, which are dynamically validated against machine learning-simulated color vision deficiency conditions and WCAG contrast requirements, and further refined through user feedback.

15. The system of claim 9, further configured to generate a visual mapping that dynamically highlights problematic color pairs in existing palettes based on machine learning-simulated assessments, and to facilitate user-guided updates prior to automated finalization of the accessible color outputs.

16. A non-transitory computer-readable medium storing program instructions which, when executed by one or more processors, cause a system to perform the method of claim 1, the instructions including: a one-time prediction of color vision deficiencies warnings using a first pre-trained machine-learning module; a one-time simulation of corresponding contrasted colors using a second pre-trained machine-learning module; a fixed-formula computation of accessibility scores and contrast predictions without iterative updating; and the generation of accessible color outputs that satisfy predefined fixed accessibility criteria, explicitly excluding any iterative updating process.

17. The non-transitory computer-readable medium of claim 16, wherein the method further comprises adjusting a final color selection process by penalizing pairs whose confusion distance, relative luminance, shift, chromatic distinguishability in a color space (e.g., OKLab) is below a predetermined threshold.

18. The non-transitory computer-readable medium of claim 16, wherein filtering color pairs uses both a CVDx ratio threshold and a user-defined contrast target, thereby ensuring each output pairing remains color-blind safe and meets a desired contrast ratio level.

19. The non-transitory computer-readable medium of claim 16, wherein generating the accessible color outputs includes compiling a design system containing thematically linked color ramps, gradients, and pairings verified to be simultaneously color-blind safe and WCAG-compliant.
